(19) United States
(12) Patent Application Publication
(10) Pub. No.: US 2011/0229213 A1
(43) Pub. Date: Sep. 22, 2011

(54) TONER DISCHARGING DEVICE, TONER CARTRIDGE, AND IMAGE FORMING APPARATUS

(76) Inventors: Koichi Mihara, Osaka (JP); Takafumi Nagai, Osaka (JP)

(21) Appl. No.: 13/048,307

(22) Filed: Mar. 15, 2011

(30) Foreign Application Priority Data
Mar. 18, 2010 (JP) P2010-063305

(51) Int. Cl. G03G 15/08

(52) U.S. Cl. 399/263

(57) ABSTRACT

A toner discharging device, a toner cartridge, and an image forming apparatus in which the occurrence of the locking phenomenon is prevented are provided. A toner discharging device includes a discharge container including a wall portion which defines an inner space and has a reception port and a discharge port, and a discharge member which includes an inner spiral blade moving toner in a direction H1, an outer spiral blade moving toner in a direction H2, and a rotation shaft. At least a part of the wall portion surrounds both the inner spiral blade and the outer spiral blade along an axial line direction of the rotation shaft, and the discharge port is formed on the part of the wall portion.

### CROSS-REFERENCE TO RELATED APPLICATION

This application claims priority to Japanese Patent Application No. 2010-063305, which was filed on Mar. 18, 2010, the contents of which are incorporated herein by reference in its entirety.

### BACKGROUND OF THE TECHNOLOGY

1. Field of the Technology

The present technology relates to a toner discharging device, a toner cartridge, and an image forming apparatus.

2. Description of Related Art

An electrophotographic image forming apparatus forms images by performing development using a toner contained in a developing device. In the field of such an image forming apparatus, a toner cartridge that supplies toner to the developing device is known. The toner cartridge is configured such that the toner contained in the toner cartridge is supplied to the developing device when the toner in the developing device is consumed by image formation and the amount thereof becomes insufficient.

For example, Japanese Unexamined Patent Publication JP-A 2006-235255 discloses a toner cartridge which includes a storage container which stores toner, a discharge container extended from the storage container and having a discharge port through which toner is discharged, and a discharge member which conveys toner in the storage container to the discharge container and discharges the toner through the discharge port.

Moreover, Japanese Unexamined Patent Publication JP-A 2008-32769 discloses a discharger which includes a discharge container having a discharge port through which toner is discharged and a discharge member which discharges toner in the discharge container through the discharge port. The discharge member disclosed in JP-A 2008-32769 includes a rotation shaft and two spiral blades provided around the rotation shaft, and the two spiral blades are configured so as to convey toner in opposite directions.

In general, when a toner cartridge is transported or left unused for a long period, the toner in the toner cartridge decreases in mobility. In the toner cartridge disclosed in JP-A 2006-235255, when the mobility of toner decreases, the toner is not easily discharged through the discharge port and becomes caught between the discharge member and the inner wall surface of the discharge container and compressed. When the toner is compressed, the torque necessary for rotating the discharge member at a constant rotation speed (hereinafter referred to as “driving torque”) increases. Thus, the driving torque becomes larger than the torque which a driving portion such as a motor connected to the discharge member applies to the discharge member. As a result, a locking phenomenon where the rotation of the discharge member stops occurs.

In the discharger disclosed in JP-A 2008-32769, since two spiral blades are configured so as to convey toner in opposite directions, toner is caught between the two spiral blades and compressed. Therefore, like the toner cartridge disclosed in JP-A 2006-235255, the driving torque increases, and the locking phenomenon occurs.

### SUMMARY OF THE TECHNOLOGY

The technology has been made to solve the above-described problem and an object thereof is to provide a toner discharging device, a toner cartridge, and an image forming apparatus in which occurrence of the locking phenomenon is prevented.

The technology provides a toner discharging device comprising:

a discharge container comprising a wall portion which defines an inner space and has a reception port for receiving toner and a discharge port for discharging toner; and

a discharge member provided in the discharge container, the discharge member including:

a rotation shaft;

an inner spiral blade provided around the rotation shaft, the inner spiral blade moving the toner in the discharge container in one direction of an axial line direction of the rotation shaft by rotation following the rotation of the rotation shaft; and

an outer spiral blade provided around the inner spiral blade, the outer spiral blade moving the toner in the discharge container in another direction of the axial line direction of the rotation shaft by rotation following the rotation of the rotation shaft,

at least a part of the wall portion of the discharge container surrounding both the inner spiral blade and the outer spiral blade along the axial line direction of the rotation shaft, and the discharge port being formed on the part of the wall portion.

The toner in the discharge container at a position relatively close to the rotation shaft is conveyed in one direction of the axial line direction by the inner spiral blade, and at the same time, is also conveyed in the other direction of the axial line direction by the outer spiral blade. Since two kinds of toner flows are formed at the same time, the mobility of the toner is improved. Therefore, the toner can be securely discharged from the discharge port of the discharge container, and the occurrence of the locking phenomenon can be prevented.

Further, it is preferable that the one direction is a direction directed from the reception port to the discharge port in the axial line direction,

the inner spiral blade is a conical spiral blade of which an inner diameter is constant and of which an outer diameter continuously decreases as it advances in the one direction, and

the outer spiral blade is an annular spiral blade of which an outer diameter is constant and of which an inner diameter continuously increases as it advances in the other direction.

The inner spiral blade is a conical spiral blade which conveys toner in the direction from the reception port to the discharge port, and the outer spiral blade is an annular spiral blade which conveys toner in the direction from the discharge port to the reception port. Since the inner spiral blade is a conical spiral blade, the amount of conveyed toner decreases gradually as it advances from the reception port to the discharge port. Since the outer spiral blade is an annular spiral blade, the amount of conveyed toner decreases gradually as it advances from the discharge port to the reception port. Therefore, the flow of toner can be smoothly changed by the inner spiral blade and the outer spiral blade, and an abrupt increase in the driving torque can be prevented.

Further, it is preferable that the one direction is a direction directed from the discharge port to the reception port in the axial line direction,

the inner spiral blade is a conical spiral blade of which an inner diameter is constant and of which an outer diameter continuously decreases as it advances in the one direction, and

the outer spiral blade is an annular spiral blade of which an outer diameter is constant and of which an inner diameter continuously increases as it advances in the other direction.

The inner spiral blade is a conical spiral blade which conveys toner in the direction from the discharge port to the reception port, and the outer spiral blade is an annular spiral blade which conveys toner in the direction from the reception port to the discharge port. Since the inner spiral blade is a conical spiral blade, the amount of conveyed toner decreases gradually as it advances from the reception port to the discharge port. Since the outer spiral blade is an annular spiral blade, the amount of conveyed toner decreases gradually as it advances from the discharge port to the reception port. Therefore, the flow of toner can be smoothly changed by the inner spiral blade and the outer spiral blade, and an abrupt increase in the driving torque can be prevented.

Further, it is preferable that the outer spiral blade is formed of an elastic sponge.

By forming the outer spiral blade of an elastic sponge, it is possible to suppress a load applied to the toner resulting from the two kinds of toner flows.

The technology also provides a toner cartridge comprising:

the toner discharging device mentioned above;

a storage container which stores toner;

a conveying container having a conveying port through which toner is conveyed to the discharge container;

a scooping member which is provided in the storage container so as to scoop up the toner in the storage container into the conveying container; and

a conveying member which is provided in the conveying container so as to convey the toner in the conveying container towards the conveying port,

the discharge container and the conveying container being connected so that the toner in the conveying container can be moved to the discharge container through the conveying port and the reception port.

Since the toner cartridge comprises the toner discharging device mentioned above, it is possible to prevent the occurrence of the locking phenomenon.

The technology also provides an electrophotographic image forming apparatus comprising a developing device,

the toner cartridge mentioned above being provided as a toner cartridge for supplying toner to the developing device.

Since the image forming apparatus comprises the toner cartridge mentioned above, toner can be stably supplied to the developing device for a long period. Therefore, the image forming apparatus can form images stably for a long period.

### BRIEF DESCRIPTION OF THE DRAWINGS

Other and further objects, features, and advantages will be more explicit from the following detailed description taken with reference to the drawings wherein:

FIG. 1 is a schematic diagram showing a configuration of an image forming apparatus;

FIG. 2 is a perspective view showing a toner cartridge unit;

FIG. 3 is a schematic diagram showing an inner configuration of a toner cartridge;

FIG. 4 is a cross-sectional view of the toner cartridge taken along the line A-A in FIG. 3;

FIG. 5 is an end view of the toner cartridge taken along the line B-B in FIG. 4;

FIGS. 6A and 6B are diagrams illustrating one cyclic spiral blade surface;

FIG. 7 is a schematic diagram showing an inner configuration of a toner discharging device;

FIGS. 8A and 8B are diagrams showing an inner spiral blade and an outer spiral blade;

FIGS. 9A to 9D are diagrams illustrating one cyclic conical spiral blade surface;

FIGS. 10A to 10D are diagrams illustrating one cyclic annular spiral blade surface;

FIG. 11 is a schematic diagram showing an inner configuration of a toner cartridge;

FIG. 12 is an end view of the toner cartridge;

FIG. 13 is a schematic diagram showing an inner configuration of a toner discharging device; and

FIGS. 14A and 14B are diagrams showing an inner spiral blade and an outer spiral blade.

### DETAILED DESCRIPTION

Now referring to the drawings, preferred embodiments are described below.

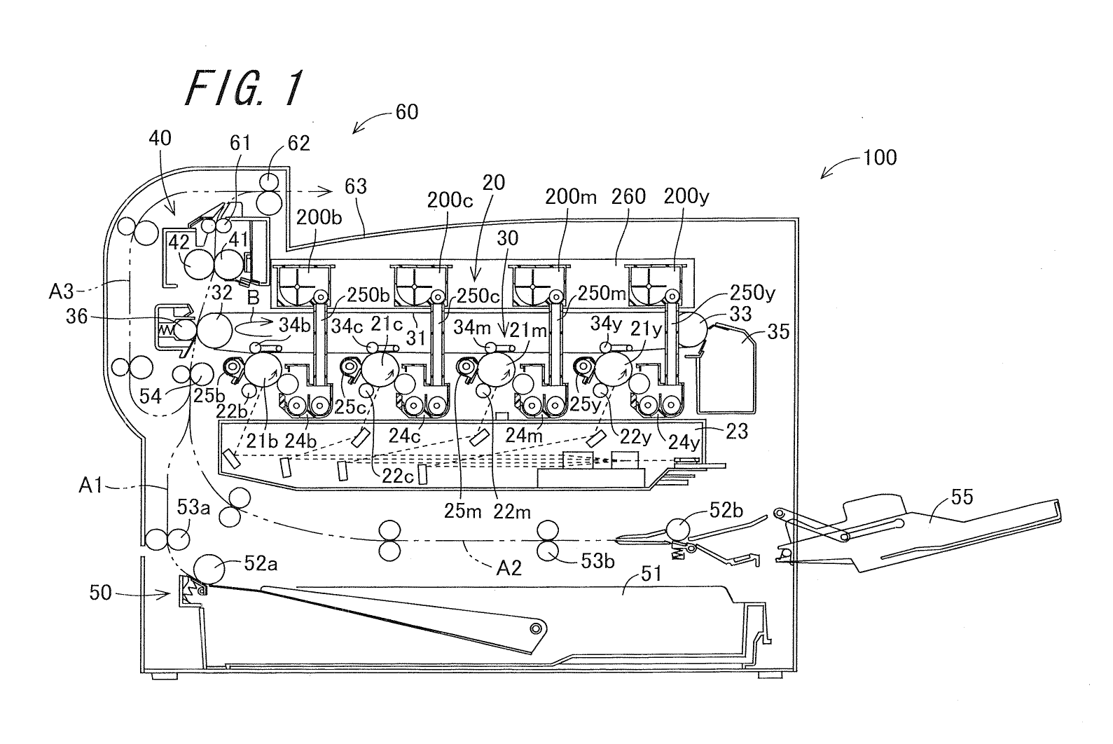

First, an image forming apparatus 100 having a toner cartridge 200 according to a first embodiment will be described. FIG. 1 is a schematic diagram showing a configuration of the image forming apparatus 100. The image forming apparatus 100 is a multi-functional peripheral which has a copier function, a printer function, and a facsimile function. A full-color or monochrome image is formed on a recording medium in accordance with the image information transmitted to the image forming apparatus 100. The image forming apparatus 100 has three print modes, that is, a copier mode (copying mode), a printer mode, and a facsimile mode. The print mode is selected by a control unit section (not shown) in accordance with the operation input from an operation portion (not shown) and reception of a print job from a personal computer, a mobile terminal device, an information recording medium, or an external device using a memory device.

The image forming apparatus 100 includes a toner image forming section 20, a transfer section 30, a fixing section 40, a recording medium feeding section 50, a discharging section 60, and a control unit section (not shown). The toner image forming section 20 includes photoreceptor drums 21b, 21c, 21m, and 21y, charging sections 22b, 22c, 22m, and 22y, an exposure unit 23, developing devices 24b, 24c, 24m, and 24y, cleaning units 25b, 25c, 25m, and 25y, and toner cartridges 200b, 200c, 200m, and 200y. The toner cartridges 200b, 200c, 200m, and 200y are provided as a toner cartridge unit 260. Description of the toner cartridge unit 260 will be provided later. The transfer section 30 includes an intermediate transfer belt 31, a driving roller 32, driven roller 33, intermediate transfer rollers 34b, 34c, 34m, and 34y, a transfer belt cleaning unit 35, and a transfer roller 36.

The photoreceptor drum 21, the charging section 22, the developing device 24, the cleaning unit 25, the toner cartridge 200, and the intermediate transfer roller 34 are provided in four sets so as to correspond to the image information of the respective colors of black (b), cyan (c), magenta (m), and yellow (y) which are included in the color image information. In this specification, when the four sets of respective components provided for the respective colors are distinguished, letters indicating the respective colors are affixed to the end of the numbers representing the respective components, and combinations of the numbers and alphabets are used as the reference numerals. When the respective components are collectively referred, only the numerals representing the respective components are used as the reference numerals.

The photoreceptor drum 21 is supported so as to be rotatable around an axial line thereof by a driving section (not shown) and includes a conductive substrate (not shown) and a photoconductive layer (not shown) formed on the surface of the conductive substrate. The conductive substrate can be formed in various shapes such as a cylindrical shape, a circular columnar shape, and a thin-film sheet shape. The photoconductive layer is formed of a material which exhibits conductive properties upon irradiation of light. As for the photoreceptor drum 21, a structure which includes a cylindrical member (conductive substrate) formed of aluminum and a thin film (photoconductive layer) formed on the outer circumferential surface of the cylindrical member and formed of amorphous silicon (a-Si), selenium (Se), or an organic photoconductor (OPC) can be used, for example.

The charging section 22, the developing device 24, and the cleaning unit 25 are disposed around the photoreceptor drum 21 in that order in a rotation direction thereof. The charging section 22 is disposed vertically below the developing device 24 and the cleaning unit 25.

The charging section 22 is a device that charges a surface of the photoreceptor drum 21 so as to have predetermined polarity and potential. The charging section 22 is provided along a longitudinal direction of the photoreceptor drum 21 so as to face the photoreceptor drum 21. In the case of a contact charging type, the charging section 22 is provided in contact with the surface of the photoreceptor drum 21. In the case of a non-contact charging type, the charging section 22 is provided so as to be separated from the surface of the photoreceptor drum 21.

The charging section 22 is provided around the photoreceptor drum 21 together with the developing device 24, the cleaning unit 25, and the like. The charging section 22 is preferably provided at a position closer to the photoreceptor drum 21 than the developing device 24, the cleaning unit 25, and the like. In this way, it is possible to securely prevent the occurrence of charging faults of the photoreceptor drum 21.

As for the charging section 22, a brush-type charger, a roller-type charger, a corona discharger, an ion-generating device, or the like can be used. The brush-type charger and the roller-type charger are a charging device of contact charging type. The brush-type charger includes one which uses a charging brush, one which uses a magnetic brush, and one which uses other brushes. The corona discharger and the ion-generating device are a charging device of non-contact charging type. The corona discharger includes one which uses a wire-shaped discharge electrode, one which uses a pin-array discharge electrode, one which uses a needle-shaped discharge electrode, and one which uses other discharge electrodes.

The exposure unit 23 is disposed so that light emitted from the exposure unit 23 passes between the charging section 22 and the developing device 24 and reaches the surface of the photoreceptor drum 21. In the exposure unit 23, the charged surfaces of the photoreceptor drums 21b, 21c, 21m, and 21y are irradiated with laser beams corresponding to image information of the respective colors, whereby electrostatic latent images corresponding to the image information of the respective colors are formed on the respective surfaces of the photoreceptor drums 21b, 21c, 21m, and 21y. As for the exposure unit 23, a laser scanning unit (LSU) having a laser-emitting portion and a plurality of reflecting mirrors can be used, for example. As for the exposure unit 23, an LED (Light Emitting Diode) array and a unit in which a liquid-crystal shutter and a light source are appropriately combined may be used.

The developing device 24 includes a developer tank and a toner supply pipe 250. The developer tank contains toner in an inner space thereof. In the developer tank, a developing roller and first and second conveying screws are rotatably supported. An opening is formed on a side surface of the developer tank facing the photoreceptor drum 21, and the developing roller is provided at such a position as to face the photoreceptor drum 21 with the opening interposed therebetween.

The developing roller is a member which is disposed closest to the photoreceptor drum 21 so as to supply toner to an electrostatic latent image on the surface of the photoreceptor drum 21. When the toner is supplied, a potential having polarity opposite to the polarity of the potential of the charged toner is applied to a surface of the developing roller as a development bias voltage. In this way, the toner on the surface of the developing roller is smoothly supplied to the electrostatic latent image. The amount of toner supplied to the electrostatic latent image (the amount of which is referred to as “toner attachment amount”) can be controlled by changing the value of the development bias.

The first conveying screw is a member which faces the developing roller and supplies toner to the vicinity of the developing roller. The second conveying screw is a member which faces the first conveying screw and feeds toner which is newly supplied into the developer tank through the toner supply pipe 250 to the vicinity of the first conveying screw.

The toner supply pipe 250 is disposed so as to connect a toner supply port formed in a vertically lower part of the toner supply pipe 250 to a toner reception port formed in a vertically upper part of the developer tank. The toner supply pipe 250 supplies toner supplied from the toner cartridge 200 to the developer tank. As another embodiment, toner may be supplied directly from the toner cartridge 200 of each color to the developer tank without using the toner supply pipe 250.

A toner concentration detection sensor is provided on a bottom surface of the developer tank. The toner concentration detection sensor detects a toner concentration in the developer tank. As for the toner concentration detection sensor, a general toner concentration detection sensor can be used, and examples thereof include a transmission light detection sensor, a reflection light detection sensor, a permittivity detection sensor, and the like. Among these sensors, a permittivity detection sensor is preferred.

The toner concentration detection sensor is electrically connected to a toner concentration control section. The toner concentration control section controls so that a discharge member 320 (described later) in the toner cartridge 200 is rotated and the toner in the toner cartridge 200 is supplied into the developer tank when the toner concentration value detected by the toner concentration detection sensor is determined to be lower than a predetermined setting value.

The cleaning unit 25 is a member which removes the toner which remains on the surface of the photoreceptor drum 21 after the toner image has been transferred from the photoreceptor drum 21 to the intermediate transfer belt 31, and thus cleans the surface of the photoreceptor drum 21. As for the cleaning unit 25, a plate-shaped member for scraping toner and a container-like member for collecting the scraped toner are used, for example.

According to the toner image forming section 20, the surface of the photoreceptor drum 21 which is evenly charged by the charging section 22 is irradiated with laser beams corresponding to the image information from the exposure unit 23, whereby electrostatic latent images are formed on the surface of the photoreceptor drum 21. The toner is supplied from the developing device 24 to the electrostatic latent images on the photoreceptor drum 21, whereby toner images are formed. The toner images are transferred to the intermediate transfer belt 31 described later. The toner which remains on the surface of the photoreceptor drum 21 after the toner images has been transferred to the intermediate transfer belt 31 is removed by the cleaning unit 25.

The intermediate transfer belt 31 is an endless belt-shaped member which is disposed vertically above the photoreceptor drum 21. The intermediate transfer belt 31 is supported around the driving roller 32 and the driven roller 33 with tension to form a loop-shaped path and is turned to run in the direction indicated by an arrow B.

The driving roller 32 is provided so as to be rotatable around an axial line thereof by a driving section (not shown). The intermediate transfer belt 31 is caused to turn by rotation of the driving roller 32 in the direction indicated by the arrow B. The driven roller 33 is provided so as to be rotatable in accordance with rotation of the driving roller 32 and generates a constant tension in the intermediate transfer belt 31 so that the intermediate transfer belt 31 does not go slack.

The intermediate transfer roller 34 is provided so as to come into pressure-contact with the photoreceptor drum 21 with the intermediate transfer belt 31 interposed therebetween and be rotatable around an axial line thereof by a driving section (not shown). As for the intermediate transfer roller 34, one in which a conductive elastic member is formed on the surface of a roller made of metal (for example, stainless steel) having a diameter of 8 mm to 10 mm can be used, for example. The intermediate transfer roller 34 is connected to a power source (not shown) that applies a transfer bias voltage and has a function of transferring the toner images on the surface of the photoreceptor drum 21 to the intermediate transfer belt 31.

The transfer roller 36 is provided so as to come into pressure-contact with the driving roller 32 with the intermediate transfer belt 31 interposed therebetween and be rotatable around an axial line thereof by a driving section (not shown). In a pressure-contact portion (a transfer nip region) between the transfer roller 36 and the driving roller 32, the toner images which have been borne on the intermediate transfer belt 31 and conveyed to the pressure-contact portion are transferred to a recording medium fed from the recording medium feeding section 50 described later.

The transfer belt cleaning unit 35 is provided so as to face the driven roller 33 with the intermediate transfer belt 31 interposed therebetween and come into contact with a toner image bearing surface of the intermediate transfer belt 31. The transfer belt cleaning unit 35 is provided so as to remove and collect the toner which remains on the surface of the intermediate transfer belt 31 after the toner images have been transferred to the recording medium. When the toner remains adhering to the intermediate transfer belt 31 after the toner images have been transferred to the recording medium, there is a possibility that the residual toner adheres to the transfer roller 36 due to turning of the intermediate transfer belt 31. When the toner adheres to the transfer roller 36, the toner may contaminate the rear surface of a recording medium which is subsequently subjected to transfer.

According to the transfer section 30, when the intermediate transfer belt 31 is turned to run while making contact with the photoreceptor drum 21, a transfer bias voltage having a polarity opposite to the polarity of the charged toner on the surface of the photoreceptor drum 21 is applied to the intermediate transfer roller 34, and the toner images formed on the surface of the photoreceptor drum 21 are transferred to the intermediate transfer belt 31. The toner images of the respective colors formed by the respective photoreceptor drums 21y, 21m, 21c, and 21b are sequentially transferred and overlaid onto the intermediate transfer belt 31, whereby full-color toner images are formed. The toner images transferred to the intermediate transfer belt 31 are conveyed to the transfer nip region by turning movement of the intermediate transfer belt 31, and the toner images are transferred to the recording medium in the transfer nip region. The recording medium on which the toner images are transferred is conveyed to a fixing section 40 described later.

The recording medium feeding section 50 includes a paper feed box 51, pickup rollers 52a and 52b, conveying rollers 53a and 53b, registration rollers 54, and a paper feed tray 55. The paper feed box 51 is a container-shaped member which is disposed in a vertically lower part of the image forming apparatus 100 so as to store recording mediums at the inside of the image forming apparatus 100. The paper feed tray 55 is a tray-shaped member which is provided on an outer wall surface of the image forming apparatus 100 so as to store recording mediums outside the image forming apparatus 100. Examples of the recording medium include plain paper, color copy paper, overhead projector sheets, and postcards.

The pickup roller 52a is a member which takes out the recording mediums stored in the paper feed box 51 sheet by sheet and feeds the recording medium to a paper conveyance path A1. The conveying rollers 53a are a pair of roller-shaped members disposed so as to come into pressure-contact with each other, and convey the recording medium towards the registration rollers 54 along the paper conveyance path A1. The pickup roller 52b is a member which takes out the recording mediums stored in the paper feed tray 55 sheet by sheet and feeds the recording medium to a paper conveyance path A2. The conveying rollers 53b are a pair of roller-shaped members disposed so as to come into pressure-contact with each other, and convey the recording medium towards the registration roller 54 along the paper conveyance path A2.

The registration rollers 54 are a pair of roller-shaped members disposed so as to come into pressure-contact with each other, and feed the recording medium fed from the conveying rollers 53a and 53b to the transfer nip region in synchronization with the conveyance of the toner images borne on the intermediate transfer belt 31 to the transfer nip region.

According to the recording medium feeding section 50, the recording medium is fed from the paper feed box 51 or the paper feed tray 55 to the transfer nip region in synchronization with the conveyance of the toner images borne on the intermediate transfer belt 31 to the transfer nip region, and the toner images are transferred to the recording medium.

The fixing section 40 includes a heating roller 41 and a pressure roller 42. The heating roller 41 is controlled so as to maintain a predetermined fixing temperature. The pressure roller 42 is a roller that comes into pressure-contact with the heating roller 41. The heating roller 41 and the pressure roller 42 pinch the recording medium under application of heat, thus fusing the toner of the toner images so as to be fixed to the recording medium. The recording medium to which the toner images have been fixed is conveyed to the discharging section 60 described later.

The discharging section 60 includes conveying rollers 61, discharge rollers 62, and a discharge tray 63. The conveying rollers 61 are a pair of roller-shaped members which is disposed vertically above the fixing section 40 so as to come into pressure-contact with each other. The conveying rollers 61 convey the recording medium on which images have been fixed towards the discharge rollers 62.

The discharge rollers 62 are a pair of roller-shaped members which is disposed so as to come into contact with each other. In the case of single-side printing, the discharge rollers 62 discharge a recording medium on which single-side printing has finished to the discharge tray 63. In the case of double-side printing, the discharge rollers 62 convey a recording medium on which single-side printing has finished to the registration rollers 54 along the paper conveyance path A3 and then discharges a recording medium on which double-side printing has finished to the discharge tray 63. The discharge tray 63 is provided on the vertically upper surface of the image forming apparatus 100 so as to store recording mediums to which images have been fixed.

The image forming apparatus 100 includes the control unit section (not shown). The control unit section is provided in the vertically upper part of the internal space of the image forming apparatus 100 and includes a memory portion, a computing portion, and a control portion. To the memory portion, various setting values mediated through an operation panel (not shown) disposed on the vertically upper surface of the image forming apparatus 100, the results detected by sensors (not shown) disposed in various portions inside the image forming apparatus 100, image information from an external device and the like are inputted. Moreover, programs for executing various processes are written in the memory portion. Examples of the various processes include a recording medium determination process, an attachment amount control process, and a fixing condition control process.

As for the memory portion, memories customarily used in this technical field can be used, and examples thereof include a read-only memory (ROM), a random-access memory (RAM), and a hard disc drive (HDD). As for the external device, electrical and electronic devices which can form or obtain the image information and which can be electrically connected to the image forming apparatus 100 can be used. Examples thereof include computers, digital cameras, televisions, video recorders, DVD (Digital Versatile Disc) recorders, HD-DVD (High-Definition Digital Versatile Disc) recorders, Blu-ray disc recorders, facsimile machines, and mobile terminal devices.

The computing portion takes out various kinds of data (for example, image formation commands, detection results, and image information) written in the memory portion and the programs for various processes and then makes various determinations. The control portion sends a control signal to the respective devices provided in the image forming apparatus 100 in accordance with the determination result by the computing portion, thus performing control on operations.

The control portion and the computing portion include a processing circuit which is realized by a microcomputer, a microprocessor, and the like having a central processing unit (CPU). The control unit section includes a main power source as well as the processing circuit. The power source supplies electricity to not only the control unit section but also to respective devices provided in the image forming apparatus 100.

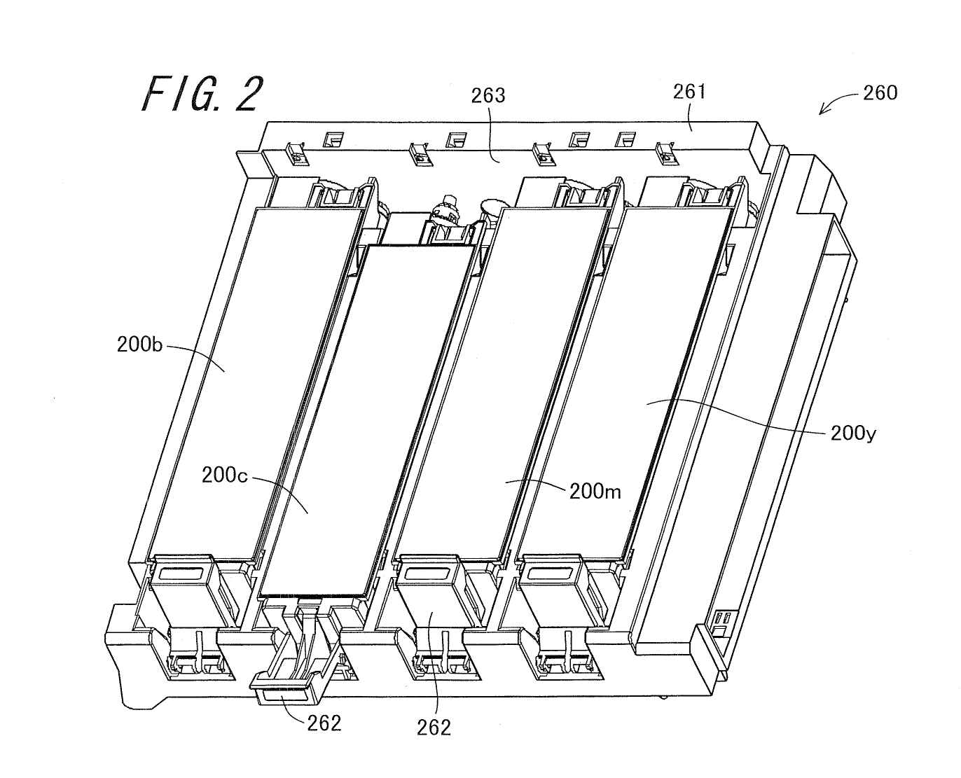

Next, the toner cartridge unit 260 will be described. FIG. 2 is a perspective view showing the toner cartridge unit 260. The toner cartridge unit 260 includes the toner cartridges 200b, 200c, 200m, and 200y and a toner cartridge mount 261. The toner cartridge mount 261 includes a locking lever 262 configured to be angularly displaceable and a stopper plate 263. Each toner cartridge 200 is fixed to the toner cartridge mount 261 when the locking lever 262 is angularly displaced towards the stopper plate 263 in a state of being mounted on the toner cartridge mount 261.

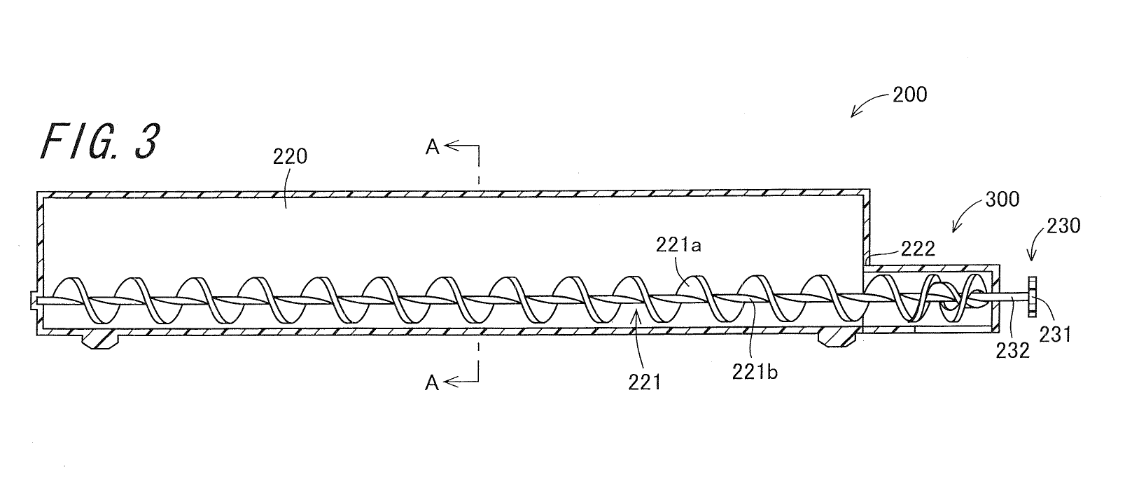

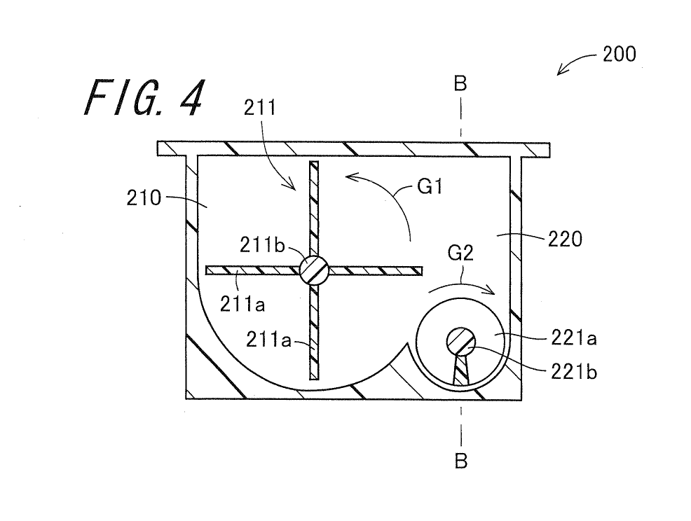

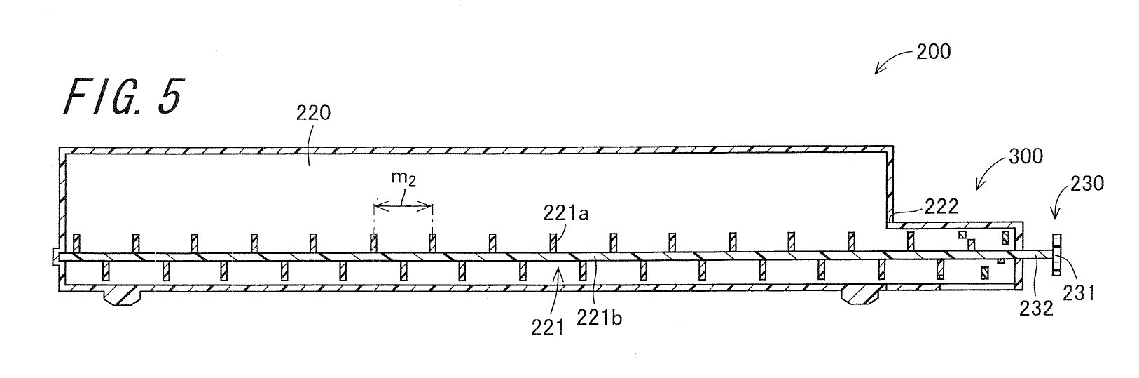

Next, the toner cartridge 200 will be described. FIG. 3 is a schematic diagram showing an inner configuration of the toner cartridge 200. FIG. 4 is a cross-sectional view of the toner cartridge 200 taken along the line A-A in FIG. 3. FIG. 5 is an end view of the toner cartridge 200 taken along the line B-B in FIG. 4. The toner cartridge 200 includes a toner discharging device 300, a storage container 210, a conveying container 220, a scooping member 211, a conveying member 221, and a transmission member 230 and supplies toner to the developing device 24.

The storage container 210 is a container-shaped member which has an inner space having an approximately semicircular columnar shape, and toner is contained in the inner space, and the scooping member 211 is provided therein. The scooping member 211 is a member which scoops up the toner in the storage container 210 by rotation thereof, thus supplying the toner to the conveying container 220. The scooping member 211 includes four scooping plates 211a and a rotation shaft 211b. The scooping plates 211a are formed on the rotation shaft 211b along the axial line direction of the rotation shaft 211b. The scooping member 211 is connected to a driving section (not shown), and the rotation shaft 211b rotates in a rotation direction G1 around an axial line thereof by the torque applied from the driving section. When the scooping plates 211a rotationally moves in accordance with rotation of the rotation shaft 211b, the toner in the storage container 210 is scooped up.

The conveying container 220 is a container-shaped member which has an inner space having an approximately semicircular columnar shape, and the inner space thereof communicates with the inner space of the storage container 210. A conveying port 222 is formed on a wall portion of the conveying container 220, and the conveying port 222 is an opening through which the toner supplied by the scooping plates 211a is conveyed to the toner discharging device 300. Moreover, the conveying member 221 is provided in the conveying container 220. The conveying member 221 includes a conveying blade 221a and a conveying shaft 221b. The conveying member 221 is a member which conveys the toner in the conveying container 220 towards the conveying port 222 when the conveying shaft 221b rotates in a rotation direction G2 around an axial line thereof.

The conveying shaft 221b is a circular columnar member having an outer diameter of 3 mm to 10 mm. The conveying shaft 221b is formed of a material, for example, such as polyethylene, polypropylene, high-impact polystyrene, or ABS resin (acrylonitrile-butadiene-styrene copolymer synthetic resin).

The conveying blade 221a is provided around the conveying shaft 221b. The conveying blade 221a is formed of a material, for example, such as polyethylene, polypropylene, high-impact polystyrene, or ABS resin. The conveying blade 221a rotates in accordance with rotation of the conveying shaft 221b, thus conveying the toner in the conveying container 220 towards the conveying port 222.

In this embodiment, the conveying blade 221a is a continuous spiral blade and is provided along a first imaginary spiral line (not shown) which advances in the axial line direction of the conveying shaft 221b by a distance corresponding to a predetermined lead angle while going around the outer circumference of the conveying shaft 221b. Here, the “lead angle” of the spiral line is an angle formed by a tangential line at an arbitrary point on the spiral line and a straight line obtained by projecting the tangential line on a plane perpendicular to the axial line direction of an imaginary circular column around which the spiral line is provided. The lead angle is an angle that is larger than 0° and smaller than 90°. The lead angle of the first imaginary spiral line can be appropriately set within the range of 20° to 70°, for example.

In this embodiment, the “spiral blade” is briefly a blade portion of a so-called auger screw, and more specifically, a member having a spiral blade surface as a main surface thereof. In this embodiment, the “spiral blade surface” is a surface formed by the trajectory of a line segment L₁ outside an imaginary circular column K₁ (radius: r₁) when the line segment L₁ is moved in one direction D₁ parallel to the axial line of the imaginary circular column K₁ while maintaining a length m₁ and an attachment angle α of the line segment L₁ in the radial direction of the imaginary circular column K₁ along one spiral line C₁ (lead angle: θ₁) provided around a side surface of the imaginary circular column K₁. Here, the “attachment angle α” is an angle formed by the line segment L₁ and a half-line extending in one direction D₁ from a tangent point of the line segment L₁ and the imaginary circular column K₁ on a plane including the axial line of the imaginary circular column K₁ and the line segment L. The attachment angle α is an angle that is larger than 0° and smaller than 180°.

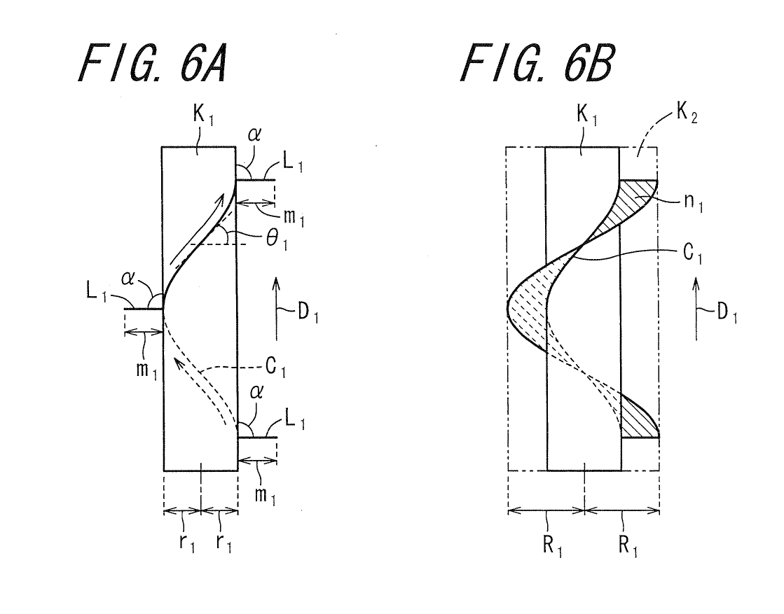

Hereinafter, as an example of the spiral blade surface, a surface obtained when a line segment is moved along one cyclic portion of a spiral line will be referred to as a spiral blade surface (“one cyclic spiral blade surface”; the same applies to other cycles). FIGS. 6A and 6B are diagrams illustrating one cyclic spiral blade surface. FIG. 6A shows the side surface of the imaginary circular column K₁, the spiral line C₁ on the side surface of the imaginary circular column K₁, and the starting and ending positions of the line segment L₁ moving in one direction D₁ on the spiral line C₁. The line segment L₁ shown on the lowermost side of the sheet surface of FIG. 6A is the starting position of the moving line segment L₁ and the line segment L₁ shown on the uppermost side is the ending position. As shown in FIG. 6A, the trajectory of the line segment L₁ when the line segment L₁ is moved in one direction D₁ along the spiral line C₁ while constantly maintaining the length m₁ and the attachment angle α (α=90° in FIG. 6A) of the line segment L₁ in the radial direction of the imaginary circular column K₁ corresponds to a spiral blade surface n₁ shown in FIG. 6B. The surface depicted by a hatched portion in FIG. 6B is the spiral blade surface n₁.

As shown in FIG. 6B, the outer circumferential portion of the spiral blade surface n₁ inscribes an imaginary circular column K₂ having the same axial line as the imaginary circular column K₁. The radius R₁ of the imaginary circular column K₂ is equal to the sum of the radius r₁ of the imaginary circular column K₁ and the length m₁ of the line segment L₁ in the radial direction of the imaginary circular column K₁.

As in this embodiment, when used as the conveying blade 221a, the spiral blade is configured so that the diameter 2r₁ of the imaginary circular column K₁ is the same as the outer diameter of the conveying shaft 221b, and the lead angle θ₁ of the spiral line C₁ is the same as the lead angle of the first imaginary spiral line. Moreover, the spiral blade is provided so that the spiral blade surface is on the side of the conveying port 222 in the axial line direction of the conveying shaft 221b, and the spiral line C₁ following the inner circumferential portion of the spiral blade is identical to the first imaginary spiral line.

At that time, the value of twice the distance between the inner circumferential portion of the conveying blade 221a and the axial line of the conveying shaft 221b, namely the inner diameter of the conveying blade 221a, corresponds to 2r₁. Moreover, the value of twice the distance between the outer circumferential portion of the conveying blade 221a and the axial line of the conveying shaft 221b, namely the outer diameter of the conveying blade 221a, corresponds to 2r₁+2m₁. The length m₁ can be appropriately set within the range of 2 mm to 20 mm, for example. Moreover, the attachment angle α may not be 90° but can be appropriately set within the range of 30° to 150°, for example, and the lead angle θ₁ can be appropriately set within the range of 20° to 70°, for example. Furthermore, a lead m₂ which is the distance between the adjacent outer circumferential portions of the conveying blade 221a in the axial line direction of the conveying shaft 221b corresponds to 2πr₁ tan θ₁. The lead m₂ can be appropriately set within the range of 10 mm to 30 mm, for example.

In this embodiment, the conveying blade 221a is a spiral blade having 13 cyclic spiral blade surfaces, and the thickness of the spiral blade is uniformly 1.5 mm. The cycle, the thickness and the like of the spiral blade can be appropriately set in accordance with a toner conveying speed, the size of the toner cartridge 200, and the like. For example, the thickness of the spiral blade used as the conveying blade 221a can be appropriately set within the range of 1 mm to 3 mm.

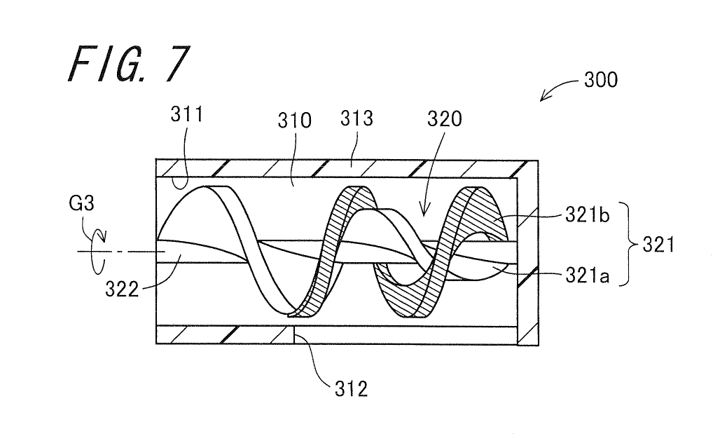

FIG. 7 is a schematic diagram showing an inner configuration of the toner discharging device 300. The toner discharging device 300 includes a discharge container 310 and a discharge member 320. The discharge container 310 is a container-shaped member which has an inner space having a circular columnar shape, and comprises a wall portion 313 which defines the inner space and has a reception port 311 for receiving toner which is an opening. The discharge container 310 and the conveying container 220 are connected so that the toner in the conveying container 220 can move into the discharge container 310 through the conveying port 222 and the reception port 311. That is, the inner space of the conveying container 220 and the inner space of the discharge container 310 communicate with each other. The discharge container 310 and the conveying container 220 may be configured as an integral member and may be configured to be detachably attached. Moreover, the wall portion 313 of the discharging container 310 has a discharge port 312 for discharging toner which is an opening which opens facing the vertically lower part of the discharge container 310. In this embodiment, the discharge port 312 is formed in an approximately rectangular shape.

The discharge member 320 is a member which is provided in the discharge container 310 so as to discharge the toner entering from the reception port 311 into the discharge container 310 through the discharge port 312. The toner discharged from the discharge port 312 is supplied to the developing device 24 through the toner supply pipe 250.

The discharge member 320 includes a rotation shaft 322 and a discharge blade 321. The rotation shaft 322 is provided so that the axial line thereof is identical to the axial line of the discharge container 310. The rotation shaft 322 has one end connected to the conveying shaft 221b and the other end connected to the transmission member 230. The rotation shaft 322, the conveying shaft 221b, and the transmission member 230 may be configured as an integral member and may be configured to be detachably attached. The rotation shaft 322 is formed of a material, for example, such as polyethylene, polypropylene, high-impact polystyrene, or ABS resin.

The discharge blade 321 is a member which rotates in accordance with rotation of the rotation shaft 322 in a rotation direction G3 around an axial line thereof, thus moving the toner in the discharge container 310. Description of the discharge blade 321 will be provided later.

The transmission member 230 includes a gear 231 and a transmission shaft 232. The transmission shaft 232 is a circular columnar member of which one end is connected to the gear 231 and the other end is connected to the rotation shaft 322. The gear 231 is a member which transmits the torque applied from a driving section (not shown) such as a motor to the transmission shaft 232. The transmission member 230 rotates at a speed of 30 rpm to 60 rpm in the rotation direction around the axial line of the transmission shaft 232 by the torque applied from a driving section (not shown).

According to the toner cartridge 200, the toner in the storage container 210 is scooped up into the conveying container 220 by the scooping member 211. Moreover, the transmission shaft 232, the rotation shaft 322, and the conveying shaft 221b are integrally rotated by the torque applied from a driving section (not shown). By the rotation of the conveying shaft 221b, the toner in the conveying container 220 is conveyed into the discharge container 310 through the conveying port 222 and the reception port 311. By the rotation of the rotation shaft 322, the toner in the discharge container 310 is discharged from the discharge port 312 and supplied into the developer tank of the developing device 24.

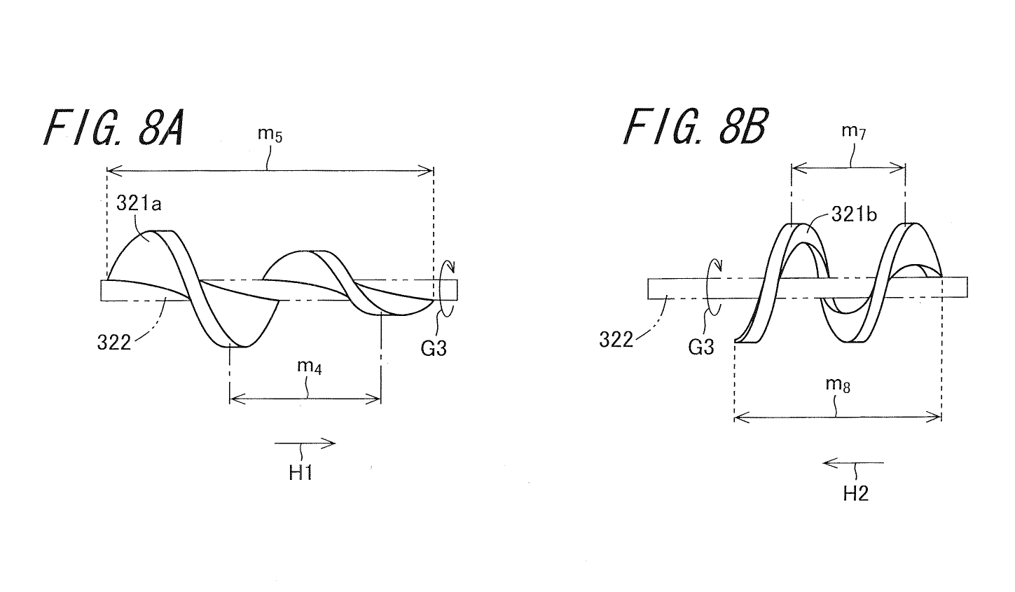

Next, the discharge blade 321 will be described. The discharge blade 321 includes an outer spiral blade 321b depicted by a hatched portion in FIG. 7 and an inner spiral blade 321a. FIGS. 8A and 8B are diagrams showing the inner spiral blade 321a and the outer spiral blade 321b, respectively. In FIG. 8A, the inner spiral blade 321a is depicted by a solid line, and the rotation shaft 322 is depicted by a two-dotted chain line. In FIG. 8B, the outer spiral blade 321b is depicted by a solid line, and the rotation shaft 322 is depicted by a two-dotted chain line.

As shown in FIG. 8A, the inner spiral blade 321a is provided around the rotation shaft 322. The inner spiral blade 321a rotates following the rotation of the rotation shaft 322 in the rotation direction G3. By the rotation, the inner spiral blade 321a conveys toner at a position relatively close to the rotation shaft 322 in a direction 31 directed from the reception port 311 to the discharge port 312, of the axial line direction of the rotation shaft 322.

As shown in FIG. 8B, the outer spiral blade 321b is provided around the inner spiral blade 321a. The outer spiral blade 321b rotates following the rotation of the rotation shaft 322 in the rotation direction G3. By the rotation, the outer spiral blade 321b conveys toner at a position relatively distant from the rotation shaft 322 in a direction H2 directed from the discharge port 312 to the reception port 311, of the axial line direction of the rotation shaft 322.

As described above, when the rotation shaft 322 of the discharge member 320 rotates, a flow of toner moving in the direction H1 and a flow of toner moving in the direction H2 are formed at a position where the inner spiral blade 321a and the outer spiral blade 321b coexist in the axial line direction of the rotation shaft 322. The discharge port 312 is formed on a part of the wall portion 313 corresponding to the position where the two kinds of toner flows are formed. That is, at least a part of the wall portion 313 of the discharge container 310 surrounds both the inner spiral blade 321a and the outer spiral blade 321b along the axial line direction of the rotation shaft 322; and the discharge port 312 is formed on the part of the wall portion 313.

In general, when a toner cartridge is transported or left unused for a long period, the toner in the toner cartridge decreases in mobility. In the toner cartridge of the related art, when the mobility of toner decreases, the toner is not quickly discharged, whereby a locking phenomenon that the rotation of the discharge member stops occurs. In contrast, in the toner discharging device 300 according to this embodiment, since two kinds of toner flows as described above are formed, the mobility of the toner is improved. For example, even when the toner is in a lump form, the lump can be crushed by the two kinds of toner flows. Therefore, the toner is securely discharged from the discharge port 312, and the occurrence of the locking phenomenon can be prevented.

The inner spiral blade 321a is formed of a material, for example, such as polyethylene, polypropylene, high-impact polystyrene, or ABS resin. In this embodiment, the inner spiral blade 321a is a continuous conical spiral blade and is provided along a second imaginary spiral line (not shown) which advances in the axial line direction of the rotation shaft 322 by a distance corresponding to a predetermined lead angle while going around the outer circumference of the rotation shaft 322. The lead angle of the second imaginary spiral line can be appropriately set within the range of 20° to 70°, for example. In this embodiment, the inner spiral blade 321a is configured so that the outer diameter of the conveying shaft 221b is identical to the outer diameter of the rotation shaft 322, and the lead angle of the first imaginary spiral line on the conveying shaft 221b is identical to the lead angle of the second imaginary spiral line on the rotation shaft 322.

In this embodiment, the “conical spiral blade” is briefly a member having such a shape that the outer diameter of a spiral blade is continuously changed while maintaining a constant inner diameter. More specifically, the conical spiral blade is a member having a conical spiral blade surface as the main surface thereof. In this embodiment, the “conical spiral blade surface” is a surface formed by the trajectory of a line segment L₂ outside an imaginary circular column K₃ (radius: r₂) when the line segment L₂ is moved in one direction D₂ parallel to the axial line of the imaginary circular column K₃ while continuously increasing the length m₃ of the line segment L₂ in the radial direction of the imaginary circular column K₃ and maintaining an attachment angle β of the line segment L₂ along one spiral line C₂ (lead angle: θ₂) provided around the side surface of the imaginary circular column K₃. Here, the “attachment angle β” is an angle formed by the line segment L₂ and a half-line extending in one direction D₂ from a tangent point of the line segment L₂ and the imaginary circular column K₃ on a plane including the axial line of the imaginary circular column K₃ and the line segment L₂. The attachment angle β is an angle that is larger than 0° and smaller than 180°.

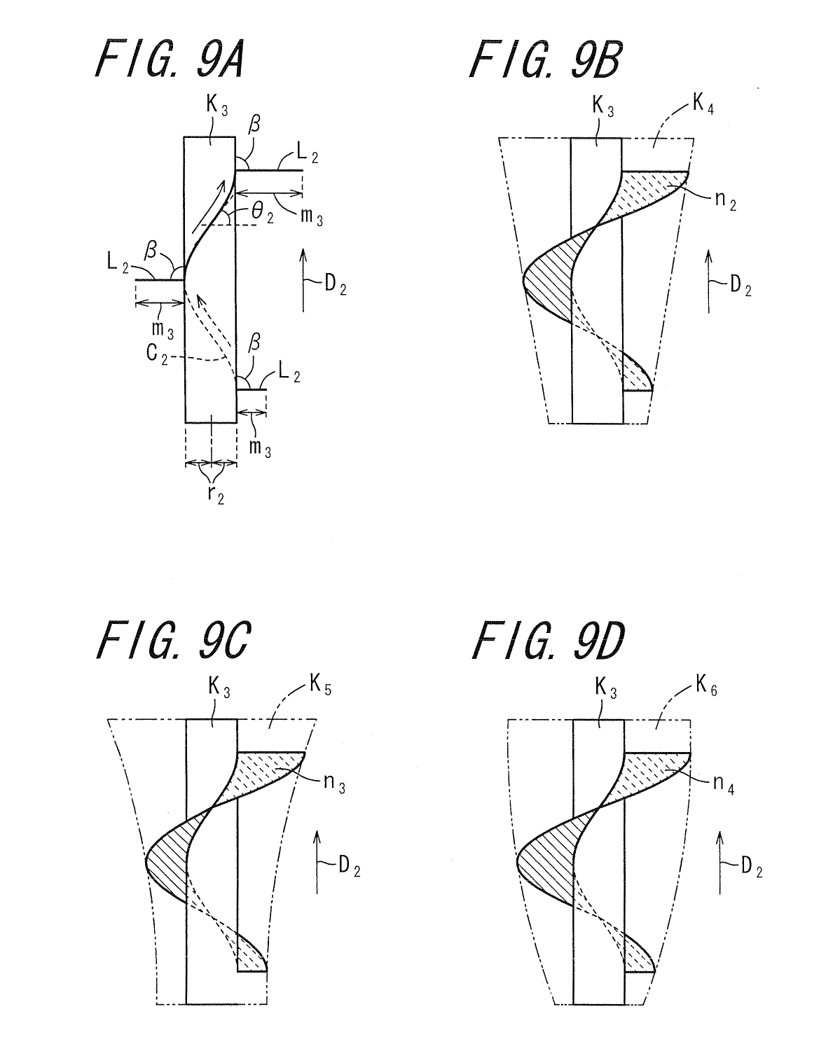

Hereinafter, as an example of the conical spiral blade surface, a surface obtained when a line segment is moved along one cyclic portion of a spiral line will be referred to as a conical spiral blade surface (“one cyclic conical spiral blade surface”; the same applies to other cycles). FIGS. 9A to 9D are diagrams illustrating one cyclic conical spiral blade surface. FIG. 9A shows the side surface of the imaginary circular column K₃, the spiral line C₂ on the side surface of the imaginary circular column K₃, and the starting and ending positions of the line segment L₂ moving in one direction D₂ on the spiral line C₂. The line segment L₂ shown on the lowermost side of the sheet surface of FIG. 9A is the starting position of the moving line segment L₂, and the line segment L₂ shown on the uppermost side is the ending position. As shown in FIG. 9A, the trajectory of the line segment L₂ when the line segment L₂ is moved in one direction D₂ along the spiral line C₂ while continuously increasing the length m₃ of the line segment L₂ in the radial direction of the imaginary circular column K₃ and constantly maintaining the attachment angle β (β=90° in FIG. 9A) of the line segment L₂ corresponds to the conical spiral blade surface.

The outer circumferential portion of the conical spiral blade surface inscribes the side surface of an imaginary truncated cone having the same axial line as the imaginary circular column K₃. In this embodiment, the “truncated cone” as used herein is a solid which has two bottom surfaces having different areas, and of which the axial line passes through the two bottom surfaces, and of which the outer diameter continuously increases in one direction of the axial line direction. The shape of the imaginary truncated cone inscribed by the conical spiral blade surface differs depending on the way that the length m₃ of the line segment L₂ changes.

FIG. 9B shows a conical spiral blade surface n₂ inscribing with an imaginary right circular truncated cone K₄. In this embodiment, the “right circular truncated cone” is a solid which is not a circular cone among two solids obtained by dividing a right circular cone on one plane parallel to the bottom surface. When the rate of change of the length m₃ of the line segment L₂ per unit moving distance along the spiral line C₂ is constant, the trajectory of the line segment L₂ corresponds to the conical spiral blade surface n₂ depicted by the hatched portion in FIG. 9B, and the outer circumferential portion thereof inscribes the side surface of the imaginary right circular truncated cone K₄.

FIG. 9C shows a conical spiral blade surface n₃ that inscribes an imaginary compressed right circular truncated cone K₅. In this embodiment, the “compressed right circular truncated cone” is a solid having such a shape that the side surface of a right circular truncated cone is curved in a direction towards the axial line. When the rate of change of the length m₃ of the line segment L₂ per unit moving distance along the spiral line C₂ gradually increases as it advances in one direction D₂, the trajectory of the line segment L₂ corresponds to the conical spiral blade surface n₃ depicted by the hatched portion in FIG. 9C, and the outer circumferential portion thereof inscribes the side surface of the imaginary compressed right circular truncated cone K₅.

FIG. 9D shows a conical spiral blade surface n₄ that inscribes an imaginary expanded right circular truncated cone K₆. In this embodiment, the “expanded right circular truncated cone” is a solid having such a shape that the side surface of a right circular truncated cone is curved in a direction away from the axial line. When the rate of change of the length m₃ of the line segment L₂ per unit moving distance along the spiral line C₂ gradually decreases as it advances in one direction D₂, the trajectory of the line segment L₂ corresponds to the conical spiral blade surface n₄ depicted by the hatched portion in FIG. 9D, and the outer circumferential portion thereof inscribes the side surface of the imaginary expanded right circular truncated cone K₆.

As in this embodiment, when used as the inner spiral blade 321a, the conical spiral blade is configured so that the diameter 2r₂ of the imaginary circular column K₃ is the same as the outer diameter of the rotation shaft 322, the lead angle θ₂ of the spiral line C₂ following the inner circumferential portion of the conical spiral blade surface is the same as the lead angle of the second imaginary spiral line, and the spiral line C₂ is identical to the second imaginary spiral line. Moreover, the conical spiral blade is provided so that the conical spiral blade surface is on the side of the discharge port 312 in the axial line direction of the rotation shaft 322, and the toner is conveyed in the direction H1 by the conical spiral blade surface.

At that time, the value of twice the distance between the inner circumferential portion of the inner spiral blade 321a and the axial line of the rotation shaft 322, namely the inner diameter of the inner spiral blade 321a, is uniformly 2r₂. Moreover, the value of twice the distance between the outer circumferential portion of the inner spiral blade 321a and the axial line of the rotation shaft 322, namely the outer diameter of the inner spiral blade 321a, changes continuously from “maximum 2m₃+2r₂” to “minimum 2m₃+2r₂” as it advances in the direction H1. The minimum value of the length m₃ can be appropriately set within the range of 0 mm to 2 mm, for example. The maximum value of the length m₃ can be appropriately set within the range of 8 mm to 20 mm, for example. In this embodiment, the maximum, value of the outer diameter of the inner spiral blade 321a is the same as the outer diameter of the conveying blade 221a of the conveying member 221, and the inner spiral blade 321a and the conveying blade 221a are smoothly connected.

In this embodiment, the attachment angle β may not be 90°, but can be appropriately set within the range of 30° to 150°. The lead angle θ₂ of the spiral line C₂ following the inner circumferential portion of the conical spiral blade can be appropriately set within the range of 20° to 70°, for example.

A lead m₄ which is the distance between the adjacent outer circumferential portions of the inner spiral blade 321a in the axial line direction of the rotation shaft 322 corresponds to 2πr₂ tan θ₂. The lead m₄ can be appropriately set within the range of 10 mm to 30 mm, for example. Moreover, the entire length m₅ of the inner spiral blade 321a in the axial line direction of the rotation shaft 322 can be appropriately set within the range of 10 mm to 40 mm, for example.

In this embodiment, the inner spiral blade 321a is a conical spiral blade having two cyclic conical spiral blade surfaces, and the thickness of the conical spiral blade is uniformly 1.5 mm. The cycle, the thickness and the like of the conical spiral blade can be appropriately set in accordance with a toner conveying speed, the size of the toner cartridge 200, and the like. For example, the thickness of the conical spiral blade used as the inner spiral blade 321a can be appropriately set within the range of 1 mm to 3 mm.

In this embodiment, the outer spiral blade 321b is a continuous annular spiral blade. In this embodiment, the “annular spiral blade” is briefly a member having such a shape that an inner diameter of a spiral blade is continuously changed while maintaining a constant outer diameter. More specifically, the annular spiral blade is a member having an annular spiral blade surface as its main surface.

In this embodiment, the “annular spiral blade surface” is a surface formed by the trajectory of a line segment L₃ inside an imaginary circular column K₇ (radius: r₃) when the line segment L₃ is moved in one direction D₃ parallel to the axial line of the imaginary circular column K₇ while continuously decreasing the length m₆ of the line segment L₃ in the radial direction of the imaginary circular column K₇ and maintaining an attachment angle δ of the line segment L₃ along one spiral line C₃ (lead angle: θ₃) provided around the side surface of the imaginary circular column K₇. Here, the “attachment angle δ” is an angle formed by the line segment L₃ and a half-line extending in one direction D₃ from a tangent point of the line segment L₃ and the imaginary circular column K₇ on a plane including the axial line of the imaginary circular column K₇ and the line segment L₃. The attachment angle δ is an angle that is larger than 0° and smaller than 180°.

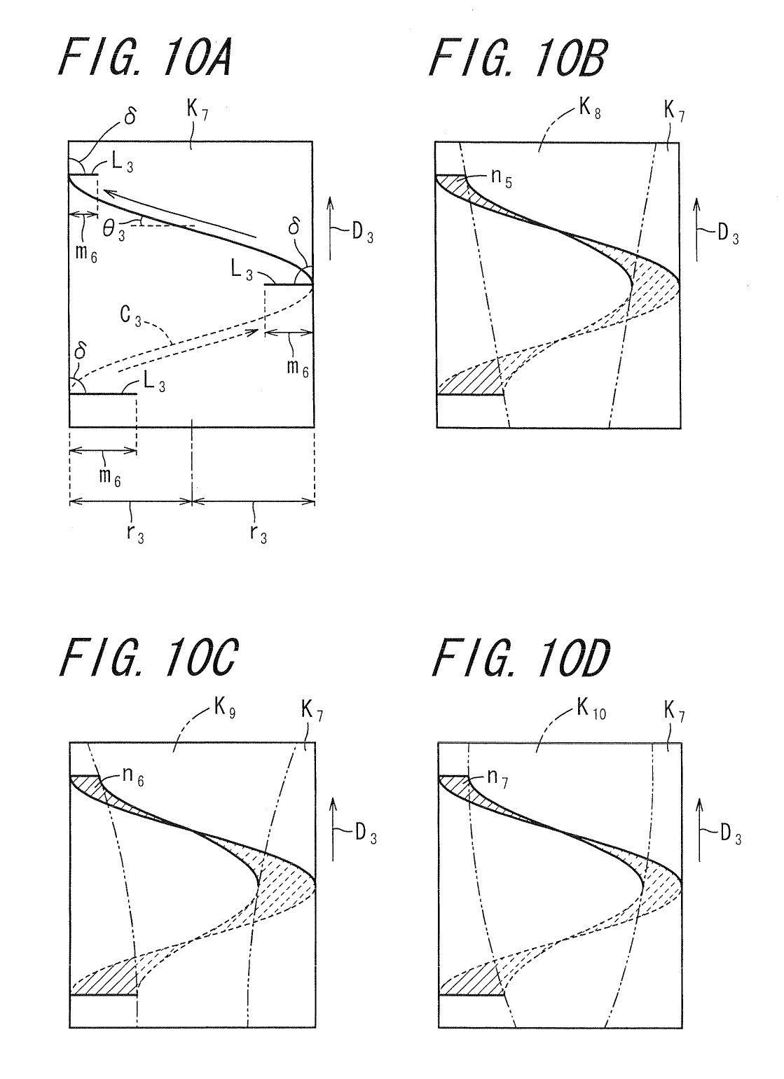

Hereinafter, as an example of the annular spiral blade surface, a surface obtained when a line segment is moved along one cyclic portion of a spiral line will be referred to as an annular spiral blade surface (“one cyclic annular spiral blade surface”; the same applies to other cycles). FIGS. 10A to 10D are diagrams illustrating one cyclic annular spiral blade surface. FIG. 10A shows the side surface of the imaginary circular column K₇, the spiral line C₃ on the side surface of the imaginary circular column K₇, and the starting and ending positions of the line segment L₃ moving in one direction D₃ on the spiral line C₃. The line segment L₃ shown on the lowermost side of the sheet surface of FIG. 10A is the starting position of the moving line segment L₃, and the line segment L₃ shown on the uppermost side is the ending position. As shown in FIG. 10A, the trajectory of the line segment L₃ when the line segment L₃ is moved in one direction D₃ along the spiral line C₃ while continuously decreasing the length m₆ of the line segment L₃ in the radial direction of the imaginary circular column K₇ and constantly maintaining the attachment angle δ (δ=90° in FIG. 10A) of the line segment L₃ corresponds to the annular spiral blade surface.

The inner circumferential portion of the annular spiral blade surface circumscribes the side surface of an imaginary truncated cone having the same axial line as the imaginary circular column K₇. The shape of the imaginary truncated cone circumscribed by the annular spiral blade surface differs depending on the way that the length m₆ of the line segment L₃ changes.

FIG. 10B shows an annular spiral blade surface n₅ that circumscribes an imaginary right circular truncated cone K₈. When the rate of change of the length m₆ of the line segment L₃ per unit moving distance along the spiral line C₃ is constant, the trajectory of the line segment L₃ corresponds to the annular spiral blade surface n₅ depicted by the hatched portion in FIG. 10B, and the inner circumferential portion thereof circumscribes the side surface of the imaginary right circular truncated cone K₈.

FIG. 10C shows an annular spiral blade surface n₆ that circumscribes an imaginary compressed right circular truncated cone K₉. When the rate of change of the length m₆ of the line segment L₃ per unit moving distance along the spiral line C₃ gradually increases as it advances in one direction D₃, the trajectory of the line segment L₃ corresponds to the annular spiral blade surface n₆ depicted by the hatched portion in FIG. 10C, and the inner circumferential portion thereof circumscribes the side surface of the imaginary compressed right circular truncated cone K₉.

FIG. 10D shows an annular spiral blade surface n₇ that circumscribes an imaginary expanded right circular truncated cone K₁₀. When the rate of change of the length m₆ of the line segment L₃ per unit moving distance along the spiral line C₃ gradually decreases as it advances in one direction D₃, the trajectory of the line segment L₃ corresponds to the annular spiral blade surface n₇ depicted by the hatched portion in FIG. 10D, and the inner circumferential portion thereof circumscribes the side surface of the imaginary expanded right circular truncated cone K₁₀.

As in this embodiment, when used as the outer spiral blade 321b, the annular spiral blade is configured so that the annular spiral blade surface is on the side of the reception port 311 in the axial line direction of the rotation shaft 322, and the toner is conveyed in the direction H2 by the annular spiral blade surface. Moreover, the annular spiral blade is provided so that the inner spiral blade 321a is present on the inner side of the side surface of the imaginary truncated cone circumscribed by the inner circumferential portion thereof. At that time, the inner spiral blade 321a and the outer spiral blade 321b may be connected by a resin or a metal at one or plural proximate portions.

When the outer spiral blade 321b is used as the annular spiral blade, the value of twice the distance between the outer circumferential portion of the outer spiral blade 321b and the axial line of the rotation shaft 322, namely the outer diameter of the outer spiral blade 321b, is uniformly 2r₃. Moreover, the value of twice the distance between the inner circumferential portion of the outer spiral blade 321b and the axial line of the rotation shaft 322, namely the inner diameter of the outer spiral blade 321b, changes continuously from “maximum 2m₆+2r₃” to “minimum 2m₆+2r₃”. The minimum value of the length m₆ can be appropriately set within the range of 0 mm to 2 mm, for example. The maximum value of the length m₆ can be appropriately set within the range of 8 mm to 20 mm, for example. In this embodiment, the maximum value of the outer diameter of the outer spiral blade 321b is the same as the outer diameter of the conveying blade 221a of the conveying member 221.

In this embodiment, the attachment angle δ may not be 90°, but can be appropriately set within the range of 30° to 150°. The lead angle θ₃ can be appropriately set within the range of 20° to 70°, for example.

A lead m₇ which is the distance between the adjacent outer circumferential portions of the outer spiral blade 321b in the axial line direction of the rotation shaft 322 corresponds to 2πr₃ tan θ₃. The lead m₇ can be appropriately set within the range of 10 mm to 30 mm, for example. Moreover, the entire length m₈ of the outer spiral blade 321b in the axial line direction of the rotation shaft 322 can be appropriately set within the range of 10 mm to 40 mm, for example.

In this embodiment, the outer spiral blade 321b is an annular spiral blade having one and three fourths cyclic annular spiral blade surfaces, and the thickness of the annular spiral blade is uniformly 1.5 mm. The cycle, the thickness and the like of the annular spiral blade can be appropriately set in accordance with a toner conveying speed, the size of the toner cartridge 200, and the like. For example, the thickness of the annular spiral blade used as the outer spiral blade 321b can be appropriately set within the range of 1 mm to 3 mm.

In this embodiment, as described above, the conical spiral blade is used as the inner spiral blade 321a and the annular spiral blade is used as the outer spiral blade 321b. The conical spiral blade is configured so that the amount of toner conveyed in the direction H1 gradually decreases as it advances in the direction H1. The annular spiral blade is configured so that the amount of toner conveyed in the direction H2 gradually decreases as it advances in the direction H2. Therefore, the flow of toner conveyed by the conveying member 221 can be smoothly changed, and an abrupt increase in the driving torque can be prevented. It is more preferable that the imaginary truncated cone inscribed by the conical spiral blade and the imaginary truncated cone circumscribed by the annular spiral blade are an expanded right circular truncated cone since the flow of toner can be changed more smoothly.

As in this embodiment, when the conical spiral blade is used as the inner spiral blade 321a and the annular spiral blade is used as the outer spiral blade 321b, it is preferable that the imaginary truncated cone inscribed by the conical spiral blade is identical to the imaginary truncated cone circumscribed by the annular spiral blade. The occurrence of the locking phenomenon can be prevented even when the imaginary truncated cone circumscribed by the outer spiral blade 321b is larger than the imaginary truncated cone inscribed by the inner spiral blade 321a, or even when at least one of the inner spiral blade 321a and the outer spiral blade 321b is configured as a spiral blade. However, the use of the inner spiral blade 321a and the outer spiral blade 321b having the same imaginary truncated cone enables the load applied to the toner to be distributed since there is no gap between the inner spiral blade 321a and the outer spiral blade 321b when the discharge member 320 is viewed from a distant position in the axial line direction of the rotation shaft 322.

The lead m₇ of the outer spiral blade 321b is preferably smaller than the lead m₄ of the inner spiral blade 321a. The direction H2 which is the direction of the toner moved by the outer spiral blade 321b is directed from the discharge port 312 to the reception port 311. Therefore, by decreasing the lead m₇ of the outer spiral blade 321b, it is possible to increase the toner discharging efficiency.

The outer spiral blade 321b and the inner spiral blade 321a may be formed of the same material and are preferably formed of an elastic sponge. The elastic sponge is a sponge which has minimal rigidity necessary for conveying toner and has such a property that a compressive deformation ratio is 50% or more and 80% or less, for example. Here, when a load of 0.1 N/cm² is applied every second in the thickness direction of a 1-cm cubic sample, and the minimum value of the thickness of the sample is F [cm], the compressive deformation ratio is a value given by the following equation (1).

Compressive Deformation Ratio [%]=(1−F)×100[%] (1)

By forming the outer spiral blade 321b from such an elastic sponge, it is possible to suppress the load applied to the toner resulting from the two kinds of toner flows of the directions H1 and H2. In this way, the image forming apparatus 100 is able to stably form high-quality images for a long period.

The openings of the elastic sponge preferably have such a size that the toner cannot enter into the opening. Specifically, an opening area is 1 μm² or more and 10 μm² or less. Moreover, an opening diameter is 1 μm or more and 3 μm or less, for example. By forming openings having such a size, it is possible to increase the abrasion between the toner and the elastic sponge while preventing the toner from entering into the openings. In this way, the toner can easily rotate together with the outer spiral blade 321b. Therefore, even when the mobility of the toner decreases, it is possible to move the toner and suppress an increase of the driving torque.

As for the elastic sponge, a urethane sponge, a rubber sponge, a polyethylene sponge, and the like can be used, and among these, the urethane sponge having excellent abrasion resistance is preferred. The use of a urethane sponge as the elastic sponge enables the life of the toner cartridge 200 to be extended. Moreover, as the elastic sponge, a continuous foam sponge having continuous foams is preferred. Since the continuous foam sponge is easily compressed or deformed compared to a single foam sponge, it is possible to suppress the excessive compression of the toner. The continuous foam sponge is obtained by a method of subjecting a kneaded material of fine calcium carbonate particles to injection molding and dipping the molded product into a hydrochloric acid solution, thus decomposing and eluting calcium carbonate powder. Alternatively, a method of molding a kneaded material of water-soluble salt and eluting the salt in water to obtain a continuous foam structure, and a method of adding a foaming agent in a resin in advance and physically breaking the walls of foams after the foaming process may be used.

Furthermore, as the elastic sponge, a conductive sponge containing a conductive agent such as carbon black is preferred. Since the conductive sponge is rarely charged even when it is brushed on the toner or against the inner wall surface of the discharge container 310, it is possible to suppress the toner from being electrostatically absorbed to the conductive sponge.

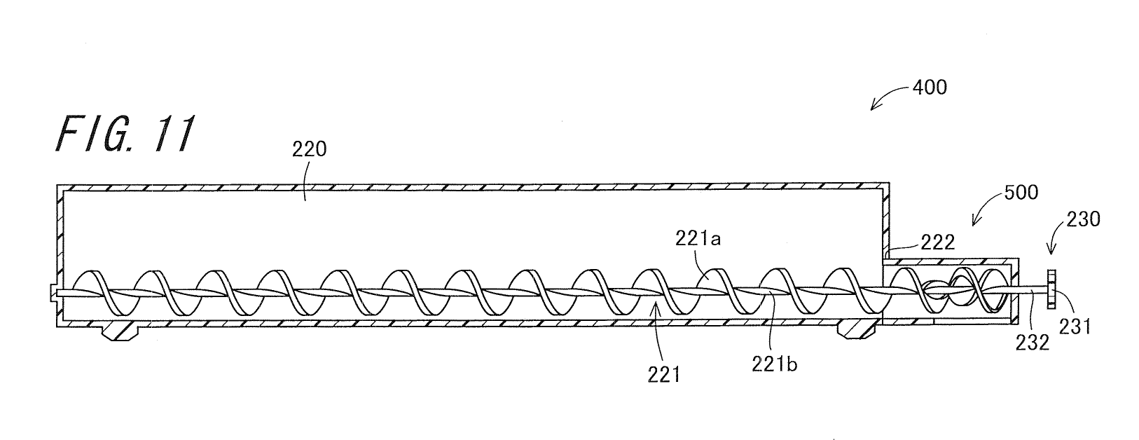

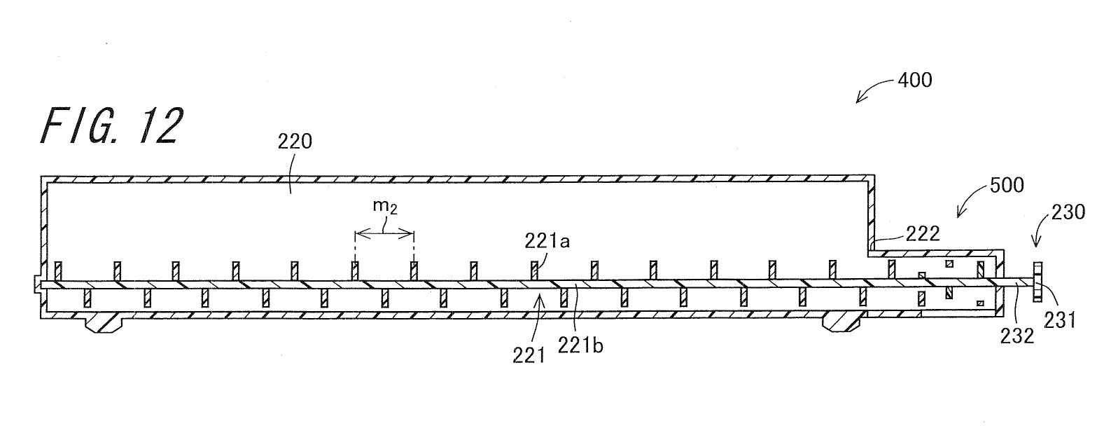

Next, a toner cartridge 400 according to a second embodiment will be described. FIG. 11 is a schematic diagram showing an inner configuration of the toner cartridge 400. FIG. 12 is an end view of the toner cartridge 400. The toner cartridge 400 includes a toner discharging device 500, a storage container 210, a conveying container 220, a scooping member 211, a conveying member 221, and a transmission member 230. The storage container 210, the conveying container 220, the scooping member 211, the conveying member 221, and the transmission member 230 are the same as those of the first embodiment, and description thereof will be omitted.

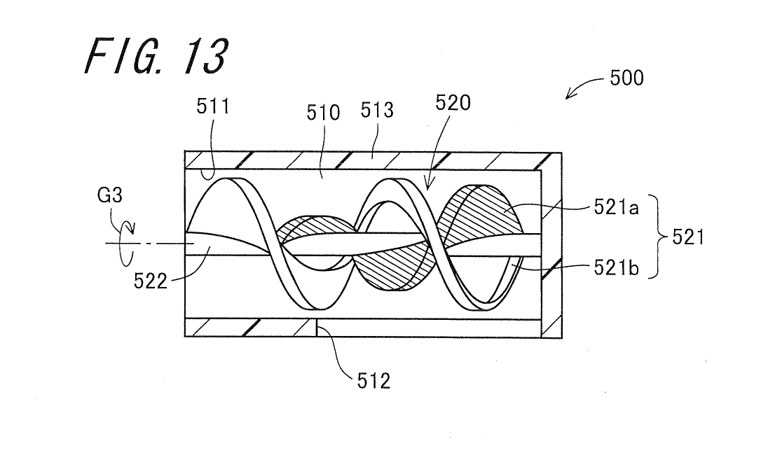

FIG. 13 is a schematic diagram showing an inner configuration of the toner discharging device 500. The toner discharging device 500 includes a discharge container 510 and a discharge member 520. The discharge container 510 is a container-shaped member which has an inner space having a circular columnar shape, and comprises a wall portion 513 which defines the inner space and has a reception port 511 for receiving toner which is an opening. The discharge container 510 and the conveying container 220 are connected so that the toner in the conveying container 220 can move into the discharge container 510 through the conveying port 222 and the reception port 511. That is, the inner space of the conveying container 220 and the inner space of the discharge container 510 communicate with each other. The discharge container 510 and the conveying container 220 may be configured as an integral member and may be configured to be detachably attached. Moreover, the wall portion 513 of the discharging container 510 has a discharge port 512 for discharging toner which is an opening which opens facing at the vertically lower part of the discharge container 510. In this embodiment, the discharge port 512 is formed in an approximately rectangular shape.

The discharge member 520 is a member which is provided in the discharge container 510 so as to discharge the toner entering from the reception port 511 into the discharge container 510 through the discharge port 512. The toner discharged from the discharge port 512 is supplied to the developing device 24 through the toner supply pipe 250.

The discharge member 520 includes a rotation shaft 522 and a discharge blade 521. The rotation shaft 522 is provided so that the axial line thereof is identical to the axial line of the discharge container 510. The rotation shaft 522 has one end connected to the conveying shaft 221b of the conveying member 221 and the other end connected to the transmission shaft 232 of the transmission member 230. The rotation shaft 522, the conveying shaft 221b, and the transmission member 230 may be configured as an integral member and may be configured to be detachably attached. In this embodiment, the outer diameter of the conveying shaft 221b is identical to the outer diameter of the rotation shaft 522. The rotation shaft 522 is formed of a material, for example, such as polyethylene, polypropylene, high-impact polystyrene, or ABS resin.

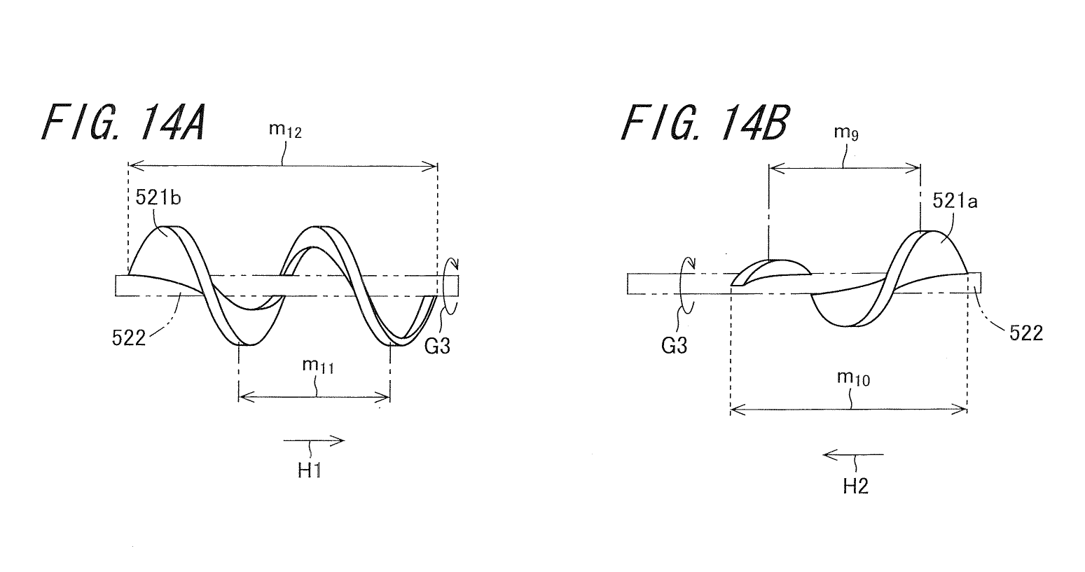

The discharge blade 521 includes an inner spiral blade 521a depicted by a hatched portion in FIG. 13 and an outer spiral blade 521b. FIGS. 14A and 14B are diagrams showing the inner spiral blade 521a and the outer spiral blade 521b, respectively. In FIG. 14A, the outer spiral blade 521b is depicted by a solid line, and the rotation shaft 522 is depicted by a two-dotted chain line. In FIG. 14B, the inner spiral blade 521a is depicted by a solid line, and the rotation shaft 522 is depicted by a two-dotted chain line.

As shown in FIG. 14B, the inner spiral blade 521a is provided around the rotation shaft 522. The inner spiral blade 521a rotates following the rotation of the rotation shaft 522 in the rotation direction G3. By the rotation, the inner spiral blade 521a conveys toner at a position relatively close to the rotation shaft 522 in a direction H2 directed from the discharge port 512 to the reception port 511, of the axial line direction of the rotation shaft 522.

As shown in FIG. 14A, the outer spiral blade 521b is provided around the inner spiral blade 521a. The outer spiral blade 521b rotates following the rotation of the rotation shaft 522 in the rotation direction G3. By the rotation, the outer spiral blade 521b conveys toner at a position relatively distant from the rotation shaft 522 in a direction H1 directed from the reception port 511 to the discharge port 512, of the axial line direction of the rotation shaft 522.

As described above, when the rotation shaft 522 of the discharge member 520 rotates, a flow of toner moving in the direction H1 and a flow of toner moving in the direction H2 are formed at a position where the inner spiral blade 521a and the outer spiral blade 521b coexist in the axial line direction of the rotation shaft 522. The discharge port 512 is formed on a part of the wall portion 513 corresponding to the position where the two kinds of toner flows are formed. That is, at least a part of the wall portion 513 of the discharge container 510 surrounds both the inner spiral blade 521a and the outer spiral blade 521b along the axial line direction of the rotation shaft 522, and the discharge port 512 is formed on the part of the wall portion 513.

In the toner discharging device 500, since two kinds of toner flows as described above are formed, the mobility of the toner is improved. Therefore, the toner is securely discharged from the discharge port 512, and the occurrence of the locking phenomenon can be prevented.

The inner spiral blade 521a is formed of a material, for example, such as polyethylene, polypropylene, high-impact polystyrene, or ABS resin. In this embodiment, the inner spiral blade 521a is a continuous conical spiral blade. The conical spiral blade is configured so that the diameter 2r₂ of the imaginary circular column K₃ shown in FIGS. 9A to 9D is identical to the outer diameter of the rotation shaft 522. Moreover, the conical spiral blade is provided so that the conical spiral blade surface is on the side of the reception port 511 in the axial line direction of the rotation shaft 522, and the toner is conveyed in the direction H2 by the conical spiral blade surface.

At that time, the value of twice the distance between the inner circumferential portion of the inner spiral blade 521a and the axial line of the rotation shaft 522, namely the inner diameter of the inner spiral blade 521a, is uniformly 2r₂. Moreover, the value of twice the distance between the outer circumferential portion of the inner spiral blade 521a and the axial line of the rotation shaft 522, namely the outer diameter of the inner spiral blade 521a, changes continuously from “maximum 2m₃+2r₂” to “minimum 2m₃+2r₂” as it advances in the direction H2. The minimum value of the length m₃ can be appropriately set within the range of 0 mm to 2 mm, for example. The maximum value of the length m₃ can be appropriately set within the range of 8 mm to 20 mm, for example. In this embodiment, the maximum value of the outer diameter of the inner spiral blade 521a is the same as the outer diameter of the conveying blade 221a of the conveying member 221.

In this embodiment, the attachment angle β may not be 90°, but can be appropriately set within the range of 30° to 150°. The lead angle θ₂ of the spiral line C₂ following the inner circumferential portion of the conical spiral blade can be appropriately set within the range of 20° to 70°, for example.

A lead m₉ which is the distance between the adjacent outer circumferential portions of the inner spiral blade 521a in the axial line direction of the rotation shaft 522 can be appropriately set within the range of 10 mm to 30 mm, for example. Moreover, the entire length m₁₀ of the inner spiral blade 521a in the axial line direction of the rotation shaft 522 can be appropriately set within the range of 10 mm to 40 mm, for example.

In this embodiment, the inner spiral blade 521a is a conical spiral blade having one and one half cyclic conical spiral blade surfaces, and the thickness of the conical spiral blade is uniformly 1.5 mm. The cycle, the thickness and the like of the conical spiral blade can be appropriately set in accordance with a toner conveying speed, the size of the toner cartridge 400, and the like. For example, the thickness of the conical spiral blade used as the inner spiral blade 521a can be appropriately set within the range of 1 mm to 3 mm.

In this embodiment, the outer spiral blade 521b is a continuous annular spiral blade. The annular spiral blade is provided so that the annular spiral blade surface is on the side of the discharge port 512 in the axial line direction of the rotation shaft 522, and the toner is conveyed in the direction H1 by the annular spiral blade surface. Moreover, the annular spiral blade is provided so that the inner spiral blade 521a is present on the inner side of the side surface of the imaginary truncated cone shown in FIGS. 10A to 10D circumscribed by the inner circumferential portion thereof. At that time, the inner spiral blade 521a and the outer spiral blade 521b may be connected by a resin or a metal at one or several proximate portions.

When the outer spiral blade 521b is used as the annular spiral blade, the value of twice the distance between the outer circumferential portion of the outer spiral blade 521b and the axial line of the rotation shaft 522, namely the outer diameter of the outer spiral blade 521b, is uniformly 2r₃. Moreover, the value of twice the distance between the inner circumferential portion of the outer spiral blade 521b and the axial line of the rotation shaft 522, namely the inner diameter of the outer spiral blade 521b, changes continuously from “maximum 2m₆+2r₃” to “minimum 2m₆+2r₃” as it advances in the direction H1. The minimum value of the length m₆ can be appropriately set within the range of 0 mm to 2 mm, for example. The maximum value of the length m₆ can be appropriately set within the range of 8 mm to 20 mm, for example. In this embodiment, the maximum value of the outer diameter of the outer spiral blade 521b is the same as the outer diameter of the conveying blade 221a of the conveying member 221, and the outer spiral blade 521b and the conveying blade 221a are smoothly connected.

In this embodiment, the attachment angle δ may not be 90°, but can be appropriately set within the range of 30° to 150°. The lead angle θ₃ can be appropriately set within the range of 20° to 70°, for example.

A lead m₁₁ which is the distance between the adjacent outer circumferential portions of the outer spiral blade 521b in the axial line direction of the rotation shaft 522 can be appropriately set within the range of 10 mm to 30 mm, for example. Moreover, the entire length m₁₂ of the outer spiral blade 521b in the axial line direction of the rotation shaft 522 can be appropriately set within the range of 10 mm to 40 mm, for example.

In this embodiment, the outer spiral blade 521b is an annular spiral blade having two cyclic annular spiral blade surfaces, and the thickness of the annular spiral blade is uniformly 1.5 mm. The cycle, the thickness and the like of the annular spiral blade can be appropriately set in accordance with a toner conveying speed, the size of the toner cartridge 400, and the like. For example, the thickness of the annular spiral blade used as the outer spiral blade 521b can be appropriately set within the range of 1 mm to 3 mm.

In this embodiment, as described above, the conical spiral blade is used as the inner spiral blade 521a and the annular spiral blade is used as the outer spiral blade 521b. The conical spiral blade is configured so that the amount of toner conveyed in the direction H2 gradually decreases as it advances in the direction H2. The annular spiral blade is configured so that the amount of toner conveyed in the direction H1 gradually decreases as it advances in the direction H1. Therefore, the flow of toner conveyed by the conveying member 221 can be smoothly changed, and an abrupt increase in the driving torque can be prevented. It is more preferable that the imaginary truncated cone inscribed by the conical spiral blade and the imaginary truncated cone circumscribed by the annular spiral blade are a compressed right circular truncated cone since the flow of toner can be changed more smoothly.

As in this embodiment, when the conical spiral blade is used as the inner spiral blade 521a and the annular spiral blade is used as the outer spiral blade 521b, it is preferable that the imaginary truncated cone inscribed by the conical spiral blade is identical to the imaginary truncated cone circumscribed by the annular spiral blade. The occurrence of the locking phenomenon can be prevented even when the imaginary truncated cone circumscribed by the outer spiral blade 521b is larger than the imaginary truncated cone inscribed by the inner spiral blade 521a, or even when at least one of the inner spiral blade 521a and the outer spiral blade 521b is configured as a spiral blade. However, the use of the inner spiral blade 521a and the outer spiral blade 521b having the same imaginary truncated cone enables the load applied to the toner to be distributed since there is no gap between the inner spiral blade 521a and the outer spiral blade 521b when the discharge member 520 is viewed from a distant position in the axial line direction of the rotation shaft 522.

The lead m₉ of the inner spiral blade 521a is preferably smaller than the lead m₁₁ of the outer spiral blade 521b. The direction H2 which is the direction of the toner moved by the inner spiral blade 521a is directed from the discharge port 512 to the reception port 511. Therefore, by decreasing the lead m₉ of the inner spiral blade 521a, it is possible to increase the toner discharging efficiency.

The outer spiral blade 521b and the inner spiral blade 521a may be formed of the same materials and are preferably formed of an elastic sponge similarly to the outer spiral blade 321b of the first embodiment.

The technology may be embodied in other specific forms without departing from the spirit or essential characteristics thereof. The present embodiments are therefore to be considered in all respects as illustrative and not restrictive, the scope of the technology being indicated by the appended claims rather than by the foregoing description and all changes which come within the meaning and the range of equivalency of the claims are therefore intended to be embraced therein.

What is claimed is:

1. A toner discharging device comprising:
a discharge container comprising a wall portion which defines an inner space and has a reception port for receiving toner and a discharge port for discharging toner; and
a discharge member provided in the discharge container, the discharge member including:
a rotation shaft;
an inner spiral blade provided around the rotation shaft, the inner spiral blade moving the toner in the discharge container in one direction of an axial line direction of the rotation shaft by rotation following the rotation of the rotation shaft; and
an outer spiral blade provided around the inner spiral blade, the outer spiral blade moving the toner in the discharge container in another direction of the axial line direction of the rotation shaft by rotation following the rotation of the rotation shaft,
at least a part of the wall portion of the discharge container surrounding both the inner spiral blade and the outer spiral blade along the axial line direction of the rotation shaft, and the discharge port being formed on the part of the wall portion.

2. The toner discharging device of claim 1, wherein the one direction is a direction directed from the reception port to the discharge port in the axial line direction,
the inner spiral blade is a conical spiral blade of which an inner diameter is constant and of which an outer diameter continuously decreases as it advances in the one direction, and
the outer spiral blade is an annular spiral blade of which an outer diameter is constant and of which an inner diameter continuously increases as it advances in the other direction.

3. The toner discharging device of claim 1, wherein the one direction is a direction directed from the discharge port to the reception port in the axial line direction,
the inner spiral blade is a conical spiral blade of which an inner diameter is constant and of which an outer diameter continuously decreases as it advances in the one direction, and
the outer spiral blade is an annular spiral blade of which an outer diameter is constant and of which an inner diameter continuously increases as it advances in the other direction.

4. The toner discharging device of claim 1, wherein the outer spiral blade is formed of an elastic sponge.

5. A toner cartridge comprising:
toner discharging device of claim 1;
a storage container which stores toner;
a conveying container having a conveying port through which toner is conveyed to the discharge container;
a scooping member which is provided in the storage container so as to scoop up the toner in the storage container into the conveying container; and
a conveying member which is provided in the conveying container so as to convey the toner in the conveying container towards the conveying port,
the discharge container and the conveying container being connected so that the toner in the conveying container can be moved to the discharge container through the conveying port and the reception port.

6. An electrophotographic image forming apparatus comprising a developing device,
the toner cartridge of claim 5 being provided as a toner cartridge for supplying toner to the developing device.
